(19) United States
(12) Patent Application Publication
(10) Pub. No.: US 2001/0018836 A1
(43) Pub. Date: Sep. 6, 2001

(54) Process for the production of prestressed or bent glass elements

(76) Inventors: Thomas Schmidt, Delligsen (DE); Frank Elstermeier, Grunenplan (DE); Stefan Biethmann, Alfeld (DE); Christoph Hermanns, Mainz (DE); Markus Schuster, Mainz (DE)

Correspondence Address: John F. Hoffman, BAKER & DANIELS, Suite 800, 111 East Wayne Street, Fort Wayne, IN, 46802, US

(21) Appl. No.: 09/748,908

(22) Filed: Dec. 27, 2000

(30) Foreign Application Priority Data
Dec. 30, 1999 (DE) 199 63 865.9
Sep. 13, 2000 (EP) 00119871.2

(51) Int. Cl. B32B 3/26; C03B 23/023; C03B 33/00; C03B 33/09; C03B 27/00

(52) U.S. Cl. 65/94; 428/174; 65/112; 65/105; 65/97; 65/95; 204/157.41

(57) ABSTRACT

The invention relates to a process for the production of prestressed and/or bent glass elements.

In order to avoid an edge processing with subsequent washing, the process according to the invention is carried out as follows:

a crude (rohe) glass plate is produced;

the glass plate is cut to the desired size;

the cutting-to-size is done by means of a laser;

after the cutting-to-size the glass plate is prestressed and/or bent.

The invention relates to prestressed or bent glass elements, especially window panes.

With prestressed glasses it is a matter, for example, of glazing glass panes, of automobile glazings such as wind protection panes, of inlay bottom plates (Einlegeboden) for refrigeration cabinets, of inspection glass-windows for baking ovens, of spherical caps (Kalotten), of sanitary utensils, of instrument coverings, of special-filtering glasses etc.

Flat glass panes that are then bent are being used nowadays for many purposes. A few uses are, for example, building glazing-panes, automobile glazings, spherical caps, sanitary utensils, instrument coverings etc.

The process for the production of prestressed glass elements comprises the following process steps:

First of all the glass body, thus, for example, a pane of glass is produced. The float process is usual, but glass panes can also be generated in another manner, for example in the drawing process or in the casting process.

There then follows the cutting of the glass plates to measure for the required end measurement; following upon the cutting-to-measure, a processing of the edges is indispensable. The edges, namely, present irregularities such as microcracks. On arising of tensions, such irregularities lead to a braking-out of glass in the edge zone or even to a propagation of the microcraks through the whole glass pane, and therewith to its breaking. For these reasons it is necessary to grind the edges of glasses before the prestressing, in order to avoid a breaking-out or breaking-through of the glass element in use.

Upon the edge treatment, in general a washing process must follow in order to remove the grinding residues of glass particles before the prestressing process.

The whole process is time consuming and involves expensive payments of personnel. This relates especially to the edge processing and the washing treatment. The edge treatment there does not always lead to the desired result. After the cutting of the glass pane to the desired measure, namely, hidden microcracks can be present, which extend relatively far into the glass surface, without this fact being perceptible in the edge process operation.

In the production of bent glass elements nowadays, the following process steps are applied:

Preparation of the glass elements (ordinarily) produced in the float process; the plates may, however, also be otherwise produced, for example in the drawing process or casting process

Cutting of the glass plates to measure to the required final dimension

Edge treatment (grinding process, optional)

Bending process

Possible prestressing process (depending on glass thickness and utilization, a thermal or a chemical process)

The sense of the edge processing lies in an improvement of yield in the bending process, for the avoidance of breakage and glass splinters. If (which is possible) the edge processing is dispensed with, there results correspondingly an increased waste during that process. In addition to the edge processing mentioned, ordinarily there must take place, before the bending process, a washing process for the removal of grinding residues and glass particles.

Underlying the invention is the problem of giving a process for the production of bent and/or prestressed glass panes, in which the disadvantages mentioned above are avoided. In particular it is to be achieved that the production process is simplified and less costly, and that, furthermore, the danger of the breaking-out or of the propagation of hair-like cracks is avoided. The process is in any case to be designed in such manner that it is possible to dispense with an edge treatment and a washing process.

This problem is solved by the features of claim 1.

In this context, the inventors have perceived the following: When the cutting of the glass plate measured to its desired final measurement is carried out by means of a laser, then an edge quality is yielded which is faultless with respect to thermal and mechanical loadability. The quality is equal that which is achieved with the conventional edge processing. By the use of a laser all hair-like cracks or microscopic breakouts from the material are avoided. The grinding of the edges is thus dispensed with. Therewith there is simultaneously eliminated the necessity of the washing. The saving in time and labor expenditure by the invention is, therefore, considerable.

Depending on the thickness (Starke) of the glass plate to be cut, it can be possible to achieve the desired dimension of the glass plate by laser-scratching (Laserritzen) process and the subsequent breaking of the glass plate. Tests have shown that even here a faultless edge quality is achieved.

The use of lasers for the cutting of materials is known, to be sure. But it was not to be expected that the cutting of glass plates present here would render unnecessary a reworking of edges and therewith also (eliminate) a washing. Without a knowledge of this factual behavior, the conventional process described at the outset had to appear more rational.

If a glass pane is to be prestressed, then by means of a laser rr respectively after the laser-scratching and the pressing through, it is prestressed in a usual manner. There, the workpiece passes through a run-through furnace (Durchlauf-Ofen) or through a reversing furnace, and thereupon through a quenching arrangement. Here a pressure tension is applied in the outer zones, and in the inner zone a pull tension. The prestressing has, as is well known, the sense of enhancing the strength of glass panes and simultaneously, in the event of a breakage, to lead to a breakup of the glass pane into fine granules.

If a glass pane is to be bent, then by means of a laser it is cut to format. An edge treatment with the appertaining washing process is eliminated.

Glass panes produced according to the invention—bent and/or prestressed—have a clearly higher cut-edge quality and an increased strength. Bent glass panes have all the advantages of glass panes that are produced according to known bending processes, without the necessity of an edge processing.

The invention can be applied to any types of glass bodies, for example, to complexly bent flat-glass panes, plane flat glasses and three-dimensional shapes.

The sequence of the process steps of “prestressing” and “bending” of the glass panes can be in the one order or the other. In general the bending will precede the prestressing.

1. Process for the production of bent and/or prestressed glass panes, with the following features:
a crude (rohe) glass plate is produced;
the glass plate is cut to the desired size;
the cutting-to-size is done by means of a laser;
after the cutting-to-size the glass plate is bent and/or prestressed.

2. Process according to claim 1, characterized in that for the achieving of the desired measurements there are performed only a laser-scratching (Laserritzen) and an ensuing breaking-trough.

3. Glass pane produced by means of a process according to claims 1 or 2.
